(19) United States
(12) Patent Application Publication
(10) Pub. No.: US 2020/0306981 A1
(43) Pub. Date: Oct. 1, 2020

(54) Methods, Devices, and Systems for Constructing an Assembly

(71) Applicant: Hall Labs LLC, Provo, UT (US)

(72) Inventors: David R. Hall, Provo, UT (US); Benjamin Jensen, Orem, UT (US); Jon Marshall, Mapleton, UT (US)

(73) Assignee: Hall Labs LLC, Provo, UT (US)

(21) Appl. No.: 16/364,031

(22) Filed: Mar. 25, 2019

(51) Int. Cl. B25J 9/16; G06K 7/10; G06K 7/14

(52) U.S. Cl. CPC B25J 9/1697; B25J 9/161; B25J 11/005; G06K 7/1417; G06K 7/10544

(57) ABSTRACT

Methods, systems, and devices for constructing an assembly are disclosed. A construction element with a machine-readable code thereon is provided. A robotic assembler is provided. The robotic assembler includes a code reader, a device for manipulating the construction element, and a controller that receives input from the code reader and provides instructions to the device. The machine-readable code is read on the construction element with the code reader. Instructions are provided to the device derived from the machine-readable code. The construction element is manipulated by the device based on the instructions.

### TECHNICAL FIELD

The methods, devices, and systems described herein relate generally to construction of an assembly.

### BACKGROUND

In construction, maintaining accuracy and precision is always critical. This is even more true in robotic assembly, as robots only follow instructions. Robots do not “eyeball” things, or shim them to make them fit, like a human. In robotic construction and assembly, inaccuracies and imprecision build up. This is especially true over long distances and modular assemblies. The ability to maintain accuracy and precision over long distances and throughout assembly of construction elements is critical to modern design and construction.

### SUMMARY

In a first aspect, the disclosure provides a method for constructing an assembly. A construction element with a machine-readable code thereon is provided. A robotic assembler is provided. The robotic assembler includes a code reader, a device for manipulating the construction element, and a controller that receives input from the code reader and provides instructions to the device. The machine-readable code is read on the construction element with the code reader. Instructions are provided to the device derived from the machine-readable code. The construction element is manipulated by the device based on the instructions.

In a second aspect, the disclosure provides an assembler for constructing an assembly. A code reader reads machine-readable codes affixed to construction elements. A manipulating device manipulates the construction elements. A controller is configured to provide instructions to the manipulating device for manipulating the construction elements derived from the machine-readable codes.

In a third aspect, the disclosure provides a system for construction. The system includes a construction element and a robotic assembler. The construction element has a machine-readable code thereon. The robotic assembler has a code reader, a controller, and an assembly device. The code reader is configured to read the machine-readable code and provide input to a controller. The controller is configured to receive input from the code reader and provide instructions to the assembly device based on the input. The assembly device is configured to receive the instructions from the controller and to manipulate the construction element based on the instructions.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of construction elements and robotic arms.

FIG. 2 is a detailed view of construction elements.

FIG. 3 is an isometric view of a robotic arm attached to a moveable platform.

FIG. 4 is an isometric view of a laser cutter and laser etcher with an I-beam.

FIG. 5 is a block diagram showing a method for constructing an assembly.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “QR code” is intended to refer broadly to two-dimensional bar codes which can be read by an imaging device. Typically, but not necessarily, these codes are made up of black squares arranged in a square grid on a white background.

The disclosures herein include methods, systems, and devices for overcoming the precision and accuracy failings of robotic construction and assembly of construction elements. Construction elements are provided with machine-readable codes. A robotic assembler, including a code reader and a device for manipulating the construction elements, is provided. These machine-readable codes are read by the code reader and provide input to a controller that translates the codes into instructions. The device for manipulating the construction elements receives the instructions and manipulates the construction elements based on the instructions. In other words, the machine-readable codes each provide instructions as to how that construction element should be handled. Information about how to assemble the construction elements is therefore found on the construction elements. In a preferred embodiment, the machine-readable code becomes a new origin for the robotic assembler to work from. Once the construction elements are manipulated, such as welding them together, the instructions direct the code reader where to find the next machine-readable code on the construction elements. The next machine-readable code thereby becomes the next new origin, and new construction elements are thereby connected. Each machine-readable code providing both instructions and a new origin eliminates stacking of tolerances—the accuracy and precision of the construction is only limited by the accuracy and precision of the machine-readable codes being placed on each construction element. Precision is only required at each connection.

In one embodiment, an entire building may be assembled by having machine-readable codes on each end of I-beams, directing the robotic assembler as to how to assemble the I-beams, how to weld them, where to weld them, and the order in which to assemble them. In this manner, the entire building may be built robotically, accurately and precisely, with minimal human involvement.

The benefits to safety are obvious from limiting the interaction of humans with large beams, suspended loads, and other safety hazards of construction. Economic benefits are also obvious, as construction will be faster, more accurate, with less rework and waste.

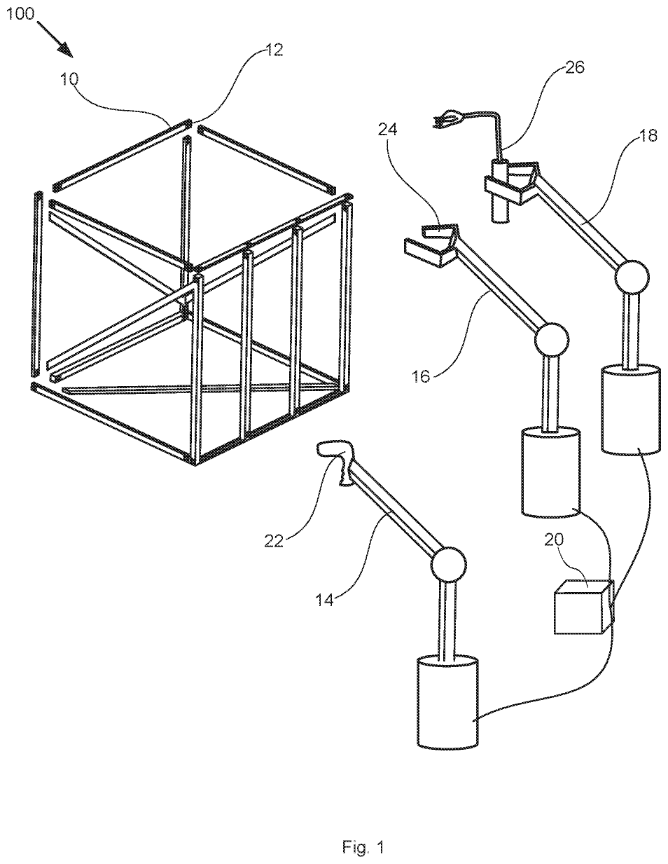

Now referring to FIG. 1, FIG. 1 is an isometric view of construction elements with robotic arms 100 as per one embodiment of the present invention. The construction elements or materials 10 have machine-readable codes 12 attached adjacent to ends of the construction materials 10. In this embodiment, the machine-readable codes are optically-readable codes, specifically QR codes.

The construction elements may come in various shapes and sizes and be made from various materials. Preferably, the construction elements are elongate pieces of a frame. Most preferably, the construction elements are tubular steel frame members, which can be welded together to make a 3-dimensional frame, such as a rectangular frame.

Alternatively, the constructions elements can be coverings that are to be attached to a frame or other elements, such as fittings, that are attached to the frame and used for connection other components, such as appliances and utilities.

The robotic arms 14, 16, and 18 communicate with a controller 20. The robotic arm 14 has a QR code attachment device and QR code reader 22 for adding QR codes 12 to the construction elements 10 and reading the QR codes 12. The robotic arm 16 has a grabber 24 that can grasp and manipulate the construction elements 10 into position. The robotic arm 18 has a welding torch 26 for attaching the construction elements 10 to each other. In this embodiment, the construction elements 10 are tagged with QR codes 12 by the QR code attachment device and QR code reader 22. The QR codes are read by the QR code attachment device and QR code reader 22. The controller 20 receives input from the code reader 22 and provides instructions to the robotic arms 16 and 18. The robotic arms use these instructions to manipulate the construction elements 10 into position and to weld them together as per the instructions.

As shown in the drawings, the preferred manipulation of the construction elements is the joining of one construction element to another. Alternatively, the instructions can include directions as to the position of the construction element, the orientation of the construction element, origin point for the assembly, method of cutting the construction element, method of coating the construction element, method of finishing the construction element, and method of joining the construction element to the other element. The instructions on position and orientation may be absolute or relative to other construction elements.

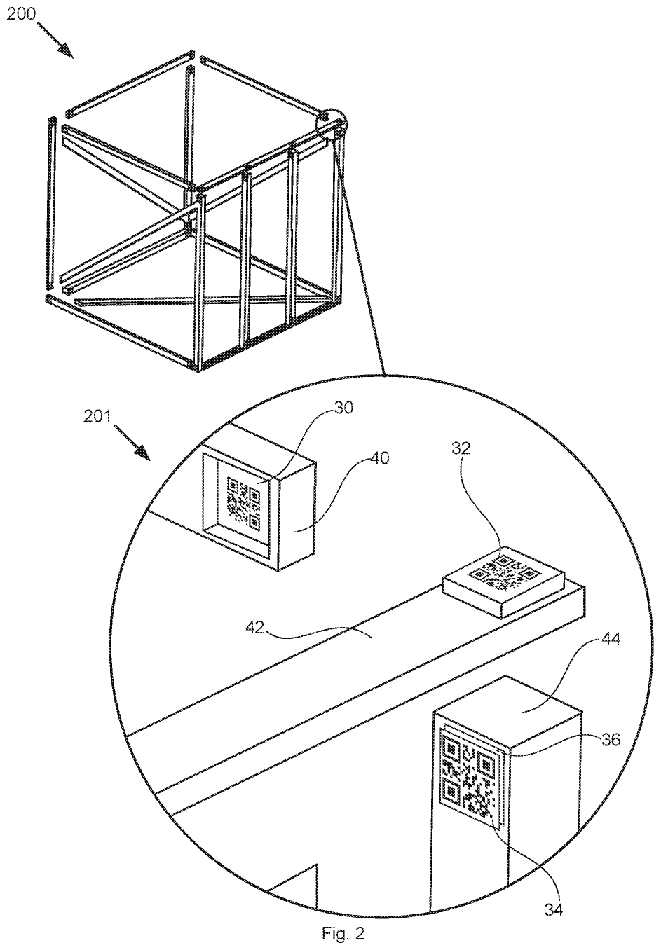

Now referring to FIG. 2, FIG. 2 is a detailed view of a corner 201 of construction elements 200 that may be used in one embodiment of the present invention. The construction elements 10 have a variety of machine-readable codes affixed thereon. A QR code 30 is etched in a recess within a construction element 40. A QR code 32 is embossed onto a protruding area on construction element 42. An RFID tag 36 is affixed to a construction element 44, with a QR code sticker 34 affixed over the RFID tag. In this last instance, the RFID tag provides a guide for the code reader to first find the RFID tag, and then to read the QR code affixed over the RFID tag. In other embodiments, GPS tags may be affixed to construction elements.

While the preferred method is to etch a QR code directly into the construction element, other methods can be used. For example, a QR code or other machine-readable code can be printed on a sticker and that sticker can be carefully attached to the construction element. Alternatively, the machine-readable code can be embossed or directly printed on the construction element.

The most preferred machine-readable code is a QR code. Alternatively, other optically-readable codes, such as simple bar codes or even numbers, letters and other symbols can be used. Likewise, although the optically-readable codes are preferably printed or formed so that they are visible to the human eye, inks and other materials may be used that are only readable by machines. Moreover, although the preferred machine-readable codes are optically-readable, other types of codes can be used, such as magnetic codes (e.g. RFID), tactile codes (e.g. bumps that can be detected).

Most preferably, in order to aid a human operator, the QR codes are printed or etched so as to include works, numbers or other symbols that would tell the human operator at least basic information about the construction element and its processing.

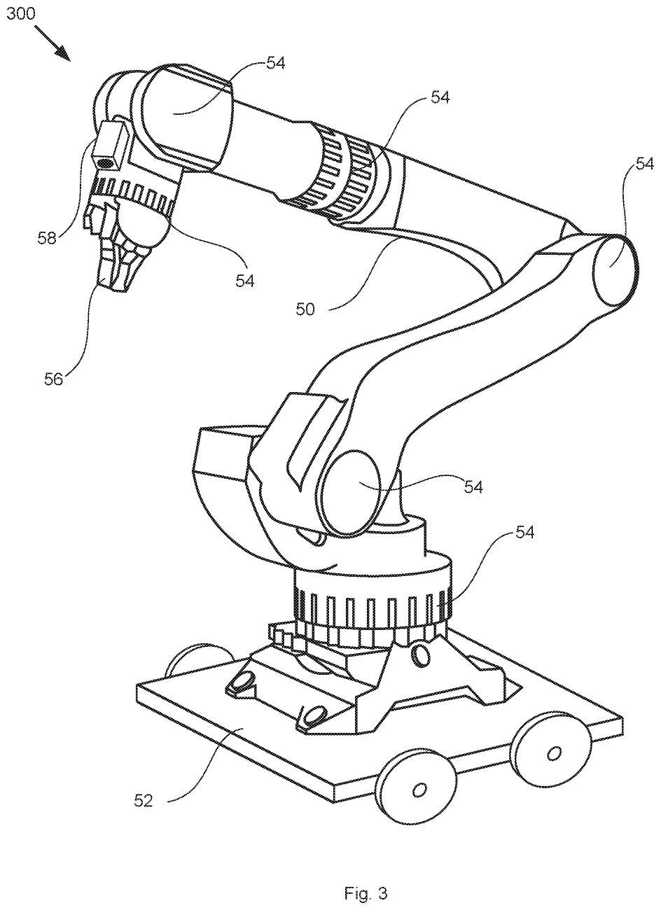

Now referring to FIG. 3, FIG. 3 is an isometric view of a robotic arm 300. The robotic arm 50 can move in six axes around joints 54. The robotic arm 50 is mounted on a movable base 52 allowing maximum maneuverability. The robotic arm 206 has a grabber 56 attached at the endpoint of the robotic arm 50 with a code reader 58 attached slightly behind the grabber 56. The robotic arm 50 reads machine-readable codes on construction elements with the code reader 58 and transmits the information to a controller. The controller transmits the information back to the robotic arm 50 as instructions for assembly. The robotic arm 50 then grasps a construction element with the grabber 56 and manipulates it into position as per the instructions. Other robotic arms then attach the construction element to other construction elements, as per the instructions from the different machine-readable codes of the different construction elements. In some embodiments, these instructions include the orientation of the construction element to the other construction elements. In some embodiments, the machine-readable code defines an origin point for assembling the construction materials. In some embodiments, the manipulating step includes welding, bolting, fitting, fastening, adhering, screwing, or combinations thereof. In some embodiments, the manipulating step includes joining the construction element to another element, and then joining the resultant sub-assembly to other sub-assemblies.

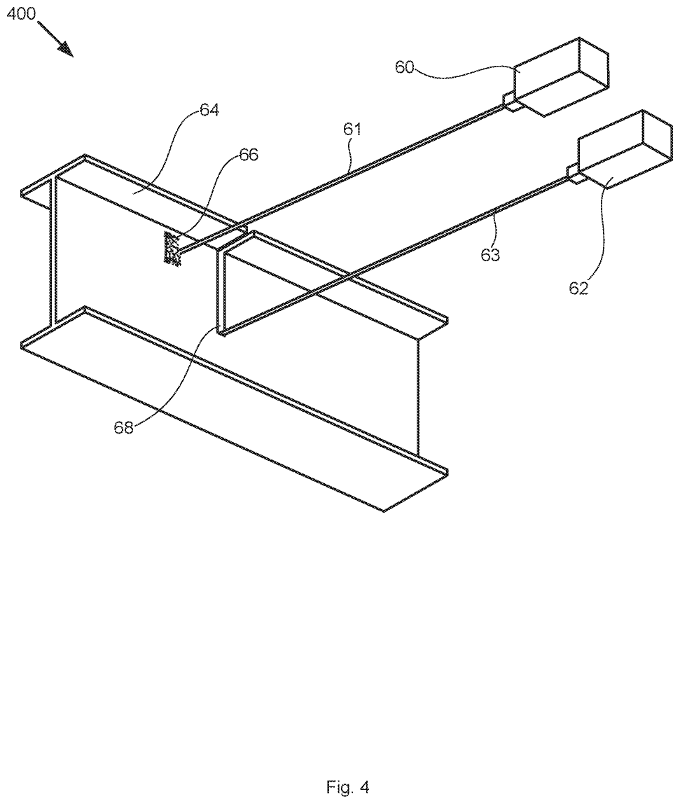

Now referring to FIG. 4, FIG. 4 is an isometric view of a laser cutter and laser etcher with an I-beam 400 that may be used in one embodiment of the present invention. An I-beam 64 is a construction element being manipulated by a shaping tool based on instructions received from a machine-readable code. In this instance, the shaper is a laser cutter 62 and is cutting 68 the I-beam with laser 63. Simultaneously, a QR code etcher 60 is etching a QR code 66 into the I-beam 64 with laser 61. The information in QR code 66 will then be used to direct further manipulation of the I-beam 64, such as assembly of the cut I-beam into an assembly by a joiner, such as a laser welder.

As shown in FIG. 4, the most preferred embodiment employs a simultaneous cutting and etching method. Alternatively, the machine-readable code can be applied to the construction element after it is cut to size, whereupon it is used to direct the joining of the construction element to an other. Still alternatively, the machine-readable code can be applied before any cutting or sizing. In such embodiments, the code carries the instructions for sizing (e.g. cutting) and for subsequent processing.

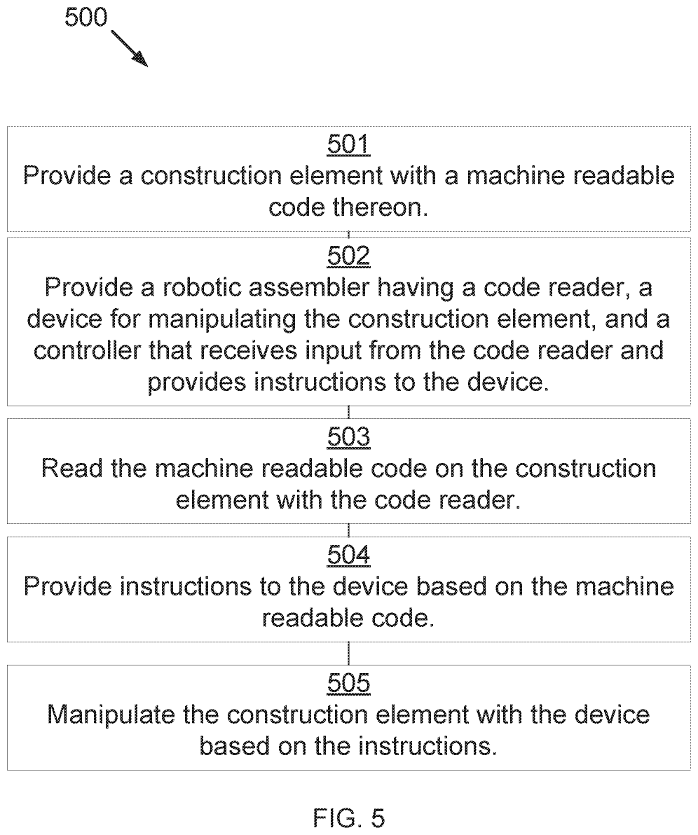

Now referring to FIG. 5, FIG. 5 is a block diagram showing a method 500 for constructing an assembly as per one embodiment of the present invention. At 501, a construction element with a machine-readable code thereon is provided. At 502, a robotic assembler is provided, the robotic assembler having a code reader, a device for manipulating the construction element, and a controller that receives input from the code reader and provides instructions to the device. At 503, the code reader reads the machine-readable code on the construction element. At 504, the instructions are provided to the device derived from the machine-readable code. At 505, the construction element is manipulated by the device based on the instructions.

In a preferred embodiment, the machine-readable code is a QR code and the code reader is a QR code reader. In another embodiment, the machine-readable code is an RFID tag and the code reader is an RFID tag reader. In another embodiment, the machine-readable code is a bar code and the code reader is a bar code reader. In another embodiment, the machine-readable code is both an RFID tag and a QR code. In another embodiment, the machine-readable code is braille.

The invention has been described with reference to various specific and preferred embodiments and techniques. Nevertheless, it is understood that many variations and modifications may be made while remaining within the spirit and scope of the invention.

What is claimed is:

1. A method for constructing an assembly comprising:
providing a construction element with a machine-readable code thereon;
providing a robotic assembler comprising a code reader, a device for manipulating the construction element, and a controller that receives input from the code reader and provides instructions to the device;
reading the machine-readable code on the construction element with the code reader;
providing instructions to the device derived from the machine-readable code;
manipulating the construction element with the device based on the instructions.

2. The invention of claim 1, wherein the manipulating step comprises joining the construction element to an other element.

3. The invention of claim 2, wherein the instructions comprise the orientation of the construction element with respect to the other element.

4. The invention of claim 2, wherein the instructions include at least one of the following: position of the construction element, orientation of the construction element, origin point for the assembly, method of cutting the construction element, method of coating the construction element, method of finishing the construction element, and method of joining the construction element to the other element.

5. [symbol] machine-readable The invention of claim 1, wherein the manipulating step comprises an action selected from the group consisting of welding, bolting, fitting, fastening, adhering, screwing, and combinations thereof.

6. The invention of claim 1, wherein the machine-readable code is an optically-readable code printed on a sticker and the sticker is tagged over a GPS tag or RF tag which transmits a location to the controller, enabling the controller to direct the robotic assembler to move the code reader to read the optically-readable code.

7. The invention of claim 1, wherein the construction element is cut by a cutting device, which cutting device is also configured to apply the machine-readable code.

8. The invention of claim 1, wherein the machine-readable code is an optically-readable code etched onto the construction element.

9. The invention of claim 1, wherein the machine-readable code is an optically-readable code embossed on the construction element.

10. The invention of claim 1, wherein the manipulating step comprises joining the construction element to at least one other element and then joining the resultant sub-assembly to other sub-assemblies.

11. An assembler for constructing an assembly comprising:
a code reader for reading machine-readable codes affixed to construction elements;
a manipulating device for manipulating the construction elements; and
a controller configured to provide instructions to the manipulating device for manipulating the construction elements derived from the machine-readable codes.

12. The invention of claim 11, further comprising a tagging device for affixing the machine-readable codes on construction elements.

13. The invention of claim 11, wherein the manipulating device comprises a joiner for joining construction elements to an other construction element according to the instructions derived from the machine-readable codes.

14. The invention of claim 13, wherein the joiner is a laser welder.

15. The invention of claim 11, wherein the manipulating device comprises a shaper for shaping the construction elements according to the instructions derived from the machine-readable codes.

16. The invention of claim 15, wherein the shaper comprises a laser cutter.

17. The invention of claim 11, wherein the manipulating device is configured to orient the construction elements with respect to an other construction element according to the instructions derived from the machine-readable codes.

18. The invention of claim 17, wherein the manipulating device is configured to hold the construction elements while another operation is performed by an other device.

19. A system for construction comprising:
a construction element with a machine-readable code thereon;
a robotic assembler comprising a code reader, a controller, and an assembly device;
the code reader configured to read the machine-readable code and provide input to a controller;
the controller configured to receive input from the code reader and provide instructions to the assembly device based on the input; and
the assembly device configured to receive the instructions from the controller and to manipulate the construction element based on the instructions.

20. The system of claim 19, wherein the machine-readable code is an optically-readable code.
